(19) United States
(12) Patent Application Publication
(10) Pub. No.: US 2009/0249238 A1
(43) Pub. Date: Oct. 1, 2009

(54) AUTOMATED DIRECTING OF DATA TO AN APPLICATION

(75) Inventors: David D. Chudy, Raleigh, NC (US); Michael G. Lisanke, Durham, NC (US); Cristian Medina, Durham, NC (US); William G. Pagan, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/058,126

(22) Filed: Mar. 28, 2008

(51) Int. Cl. G06F 3/048

(52) U.S. Cl. 715/769

(57) ABSTRACT

Embodiments of the present invention address deficiencies of the art in respect to graphical user interfaces and provide a novel and non-obvious system for managing data gathered on a computer. In one embodiment of the invention, the method includes executing a first application in a foreground of the computer and a second application in a background of the computer. The method further includes displaying a user interface metaphor for the second application. The method further includes receiving a command to direct a selection of data from the first application to the second application, while maintaining the first application in the foreground of the computer. The method further includes directing the selection of data to the second application, while maintaining the first application in the foreground of the computer.

### BACKGROUND OF THE INVENTION

1. Field of the Invention

The present invention relates to the field of graphical user interfaces and more particularly to the management of data gathered via graphical user interfaces.

2. Description of the Related Art

Individuals usually use their computers to gather, view and/or analyze data of various types. For example, the World Wide Web, a system of interlinked hypertext documents accessed via the Internet, and other online networks are a common destination for seekers of information. During the course of seeking and storing information on one's computer, the individual utilizes standard graphical user interface conventions, such as drag-and-drop and mouse clicking, to execute his desired actions. These conventions, however, do not come without their drawbacks.

A common scenario involves a user that desires to find certain information and store it in a particular location on his computer. A web browser is an example of an application that can be used to view information and a word processor is an example of an application that can be used to store information of various types, including text, images and files. In this scenario, the viewing application, such as the web browser, initially executes in the foreground of the user's computer desktop, while the storing application, such as a word processor, initially executes in the background. Typically, a user viewing a web page, or other type of user interface that displays information, comes upon a group of text, images or files that the user desires to store for later viewing. Subsequently, the user highlights the text, images or files with his mouse icon and copies them to his clipboard using a keyboard command or a selection from a pull-down menu. Next, the user brings the storing application, such as a word processor, to the foreground of the user's computer desktop. Finally, the user pastes the selected text, images or files into the storing application using a keyboard command or a selection from a pull-down menu. In order to return to viewing information in the viewing application, the user must bring the viewing application back to the foreground of the user's computer desktop.

The approach above can be tedious and time consuming for a user due to the heavy amount of back-and-forth involved between bringing different applications to the foreground and/or background of the user's computer desktop. Such a scenario can often be confusing to a user, which can translate into a loss of information or time during the data-gathering process.

Therefore, there is a need to improve upon the processes of the prior art and more particularly for a more efficient way for directing data to a storing application executing on a user's computer.

### BRIEF SUMMARY OF THE INVENTION

Embodiments of the present invention address deficiencies of the art in respect to graphical user interfaces and provide a novel and non-obvious system for managing data gathered on a computer. In one embodiment of the invention, the method includes executing a first application in a foreground of the computer and a second application in a background of the computer. The method further includes displaying a user interface metaphor for the second application. The method further includes receiving a command to direct a selection of data from the first application to the second application, while maintaining the first application in the foreground of the computer. The method further includes directing the selection of data to the second application, while maintaining the first application in the foreground of the computer.

In another embodiment of the invention, a computer program product comprising a computer usable medium embodying computer usable program code for managing data gathered on a computer is provided. The computer program product includes computer usable program code for executing a first application in a foreground of the computer and a second application in a background of the computer. The computer program product further includes computer usable program code for displaying a user interface metaphor for the second application. The computer program product further includes computer usable program code for receiving a command to direct a selection of data from the first application to the second application, while maintaining the first application in the foreground of the computer. The computer program product further includes computer usable program code for directing the selection of data to the second application, while maintaining the first application in the foreground of the computer.

In another embodiment of the present invention, a computer for managing data that is gathered is provided. The computer includes a display for displaying a user interface metaphor for a first application. The computer further includes a processor configured for executing a second application in a foreground of the computer and the first application in a background of the computer, receiving a command to direct a selection of data from the second application to the first application, while maintaining the second application in the foreground of the computer and directing the selection of data to the first application, while maintaining the second application in the foreground of the computer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an illustration of a user's computer desktop during the process of directing data to an application, in accordance with one embodiment of the present invention.

FIG. 2 is a flowchart depicting the control flow during the process of directing data to an application, in accordance with one embodiment of the present invention.

### DETAILED DESCRIPTION OF THE INVENTION

A user interface metaphor is a set of user interface visuals, actions and procedures that exploit specific knowledge that users already have of other domains. The purpose of the user interface metaphor is to give the user instantaneous knowledge about how to interact with the user interface. The folders and the file cabinet representation of the file system of an operating system is an example of a user interface metaphor. Another example is the tree view representation of a file system that helps a user to intuitively use it.

In one embodiment of the present invention, a novel and non-obvious system for managing data gathered on a computer is provided. The method includes executing a first application in a foreground of the computer and a second application in a background of the computer. Optionally, multiple second applications may be executed in a background of the computer. A user interface metaphor is displayed for the second application, such as on the computer's desktop. The present invention receives a command from the user to direct a selection of data from the first application to the second application (or multiple second applications), while maintaining the first application in the foreground of the computer. The method further includes directing the selection of data to the second application (or multiple second applications), while maintaining the first application in the foreground of the computer. In one alternative, the selection of data may be held or stored in a data construct until the second application (or multiple second applications) is/are prepared to receive the selection of data, at which time the selection of data is directed to the second application (or multiple second applications).

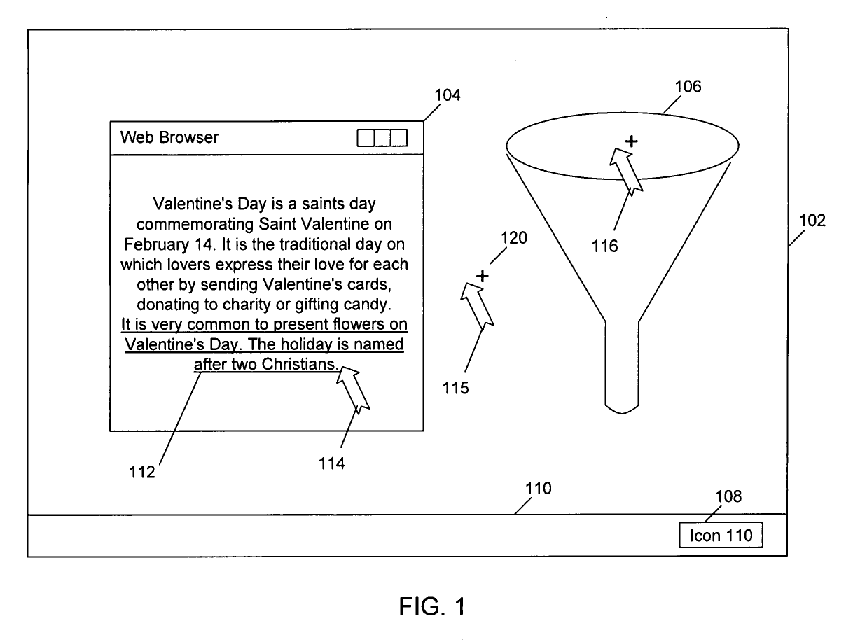

FIG. 1 is an illustration of a user's computer desktop 102 during the process of directing data to an application, in accordance with one embodiment of the present invention. FIG. 1 depicts a scenario wherein a user desires to find certain information and store it in a particular location on his computer. FIG. 1 involves a web browser 104 as an example of an application that can be used to view information. FIG. 1 further involves a web authoring program as an example of an application that can be used to store information of various types, including text, images and files. FIG. 1 also shows a graphical user interface metaphor 106, which comprises a graphic of a funnel that symbolizes the direction of data from the large portion of the funnel to the narrow portion of the funnel.

FIG. 1 shows that the web browser 104 executes in the foreground of the user's computer desktop 102. The storing application, a web authoring program, executes in the background and therefore is not shown. A taskbar icon 108 may be shown in the taskbar 110 of the user's computer desktop 102 to indicate that the web authoring program is executing in the background. In one embodiment of the present invention, multiple storing applications are executed in the background of the user's computer desktop.

The user viewing the web page on web browser 104 comes upon a group of text that the user desires to store for later viewing. The user highlights 112 the text with his mouse icon 114. Optionally, the highlighted text 112 is copied to the clipboard in response to a keyboard command from the user or a user selection from a pull-down menu. Next, the user drags and drops the highlighted text to the user interface metaphor 106. FIG. 1 shows icon 114 moving to location 115 and finally to location 116 over the user interface metaphor 106 during the drag and drop process. The “plus sign” indicator 120 over the icon 114 is an indicator that data has been copied to the clipboard and is ready to be directed to the web authoring program once it is dropped over the user interface metaphor 106.

During the process of dragging and dropping, the web browser 104 is maintained in the foreground of the user's computer desktop 102 and the web authoring application is maintained in the background of the user's computer desktop 102. As a result, the highlighted text 112 is directed to the web authoring program (or multiple storing applications) executing in the background, wherein the highlighted text 112 is processed by the web authoring program, such as pasting the text into a template.

Alternatively, after the text is highlighted 112, the user may issue a command (whether by keystrokes or a pull down menu) to direct the highlighted text 112 to the user interface metaphor 106. During this process, the web browser 104 is maintained in the foreground of the user's computer desktop 102 and the web authoring application is maintained in the background of the user's computer desktop 102. As a result, the highlighted text 112 is directed to the web authoring program (or multiple storing applications) executing in the background. In one alternative, the highlighted text 112 may be held or stored in a data construct until the web authoring program (and/or one or more storing applications) executing in the background is/are prepared to receive the highlighted text 112, at which time the highlighted text 112 is directed to the web authoring program (and/or one or more storing applications).

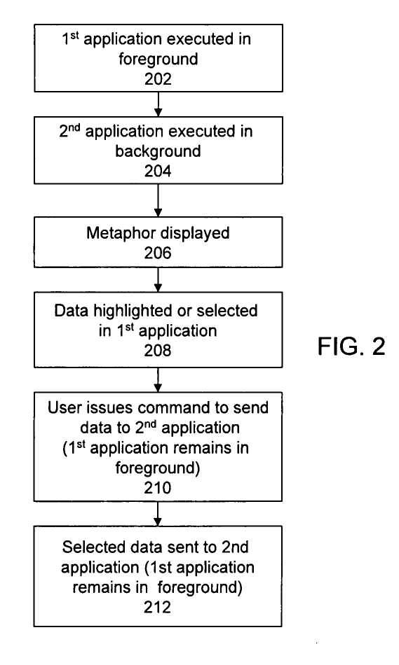

FIG. 2 is a flowchart depicting the control flow during the process of directing data to an application, in accordance with one embodiment of the present invention. The control flow of FIG. 2 depicts the process by which data is directed from a first application, such as web browser 104, executing in the foreground of the user's computer desktop 102, to a second application (or multiple storing applications) executing in the background. The process of FIG. 2 refers to the example provided in FIG. 1.

In a first step 202, a first application, such the web browser 104, is executed in the foreground of the user's computer desktop 102. In step 204, the storing application, such as a web authoring program, is executed in the background of the user's computer desktop 102. Optionally, in step 204, a taskbar icon 108 may be shown in the taskbar 110 of the user's computer desktop 102 to indicate that the web authoring program is executing in the background. In another alternative, multiple storing applications are executed in the background of the user's computer desktop. In step 206, a graphical user interface metaphor 106 is displayed on the user's computer desktop 102.

In step 208, the user comes upon a group of text that the user desires to store for later viewing and the user highlights 112 the text with his mouse icon 114. Optionally, the highlighted text 112 is copied to the clipboard in response to a keyboard command from the user or a user selection from a pull-down menu. In step 210, the user drags and drops the highlighted text to the user interface metaphor 106. During step 210, the web browser 104 is maintained in the foreground of the user's computer desktop 102 and the web authoring application is maintained in the background of the user's computer desktop 102. In an alternative to step 210, the user may issue a command (whether by keystrokes or a pull down menu) to direct the highlighted text 112 to the user interface metaphor 106.

In step 212, the highlighted text 112 is directed to the web authoring program executing in the background, wherein the highlighted text 112 is processed by the web authoring program, such as pasting the text into a template. In another alternative of step 212, the highlighted text 112 is directed to one or more storing applications executing in the background, wherein the highlighted text 112 is processed by the one or more storing applications.

In certain cases, applications executing in the background of a user's computer desktop have no object interface to which to direct a selection of data, such as highlighted text 112, at the time of a drag-drop operation, as described above. In one embodiment of step 212 of the present invention, the selection of data, or highlighted text 112, may be held or stored in a data construct until one or more storing applications are prepared to receive the selection of data, at which time the selection of data is directed to the one or more storing applications. In this embodiment, those storing applications that do have an object interface will have the selection of data directed to them immediately. Those storing applications that do not have an object interface will have the selection of data held or stored in a data construct they are prepared to receive the selection of data.

Embodiments of the present invention can take the form of an entirely hardware embodiment, an entirely software embodiment or an embodiment containing both hardware and software elements. In a preferred embodiment, the present invention is implemented in software, which includes but is not limited to firmware, resident software, microcode, and the like. Furthermore, the present invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for managing data gathered on a computer, comprising:
executing a first application in a foreground of the computer and a second application in a background of the computer;
displaying a user interface metaphor for the second application;
receiving a command to direct a selection of data from the first application to the second application, while maintaining the first application in the foreground of the computer; and
directing the selection of data to the second application, while maintaining the first application in the foreground of the computer.

2. The method of claim 1, wherein the step of executing further comprises:
displaying a user interface for the first application in the foreground of the computer.

3. The method of claim 2, wherein the first step of displaying further comprises:
displaying in the foreground a graphic that is symbolic of data reception.

4. The method of claim 2, wherein the step of receiving further comprises:
detecting a selection of data from the first application; and
detecting a drag and drop of the selection of data onto the user interface metaphor, while maintaining the first application in the foreground of the computer.

5. The method of claim 4, wherein the step of directing further comprises:
pasting the selection of data into the second application, while maintaining the first application in the foreground of the computer.

6. The method of claim 2, wherein the step of receiving further comprises:
detecting a selection of data from the first application; and
detecting a keyboard stroke combination indicating direction of the selection of data onto the user interface metaphor, while maintaining the first application in the foreground of the computer.

7. The method of claim 6, wherein the step of measuring further comprises:
pasting the selection of data into the second application, while maintaining the first application in the foreground of the computer.

8. The method of claim 1, further comprising:
executing a third application in a background of the computer; and
directing the selection of data to the third application, while maintaining the first application in the foreground of the computer.

9. The method of claim 1, further comprising:
executing a third application in a background of the computer;
storing the selection of data, responsive to detection of the third application lacking preparedness to receive data; and
directing the selection of data to the third application, while maintaining the first application in the foreground of the computer, responsive to detection of the third application preparedness to receive data.

10. A computer program product comprising a computer usable medium embodying computer usable program code for managing data gathered on a computer, comprising:
computer usable program code for executing a first application in a foreground of the computer and a second application in a background of the computer;
computer usable program code for displaying a user interface metaphor for the second application;
computer usable program code for receiving a command to direct a selection of data from the first application to the second application, while maintaining the first application in the foreground of the computer; and
computer usable program code for directing the selection of data to the second application, while maintaining the first application in the foreground of the computer.

11. The computer program product of claim 10, wherein the computer usable program code for executing further comprises:
computer usable program code for displaying a user interface for the first application in the foreground of the computer.

12. The computer program product of claim 11, wherein the first computer usable program code for displaying further comprises:
computer usable program code for displaying in the foreground a graphic that is symbolic of data reception.

13. The computer program product of claim 11, wherein the computer usable program code for receiving further comprises:
computer usable program code for detecting a selection of data from the first application; and
computer usable program code for detecting a drag and drop of the selection of data onto the user interface metaphor, while maintaining the first application in the foreground of the computer.

14. The computer program product of claim 13, wherein the computer usable program code for directing further comprises:
computer usable program code for pasting the selection of data into the second application, while maintaining the first application in the foreground of the computer.

15. The computer program product of claim 11, wherein the computer usable program code for receiving further comprises:
computer usable program code for detecting a selection of data from the first application; and
computer usable program code for detecting a keyboard stroke combination indicating direction of the selection of data onto the user interface metaphor, while maintaining the first application in the foreground of the computer.

16. The computer program product of claim 15, wherein the computer usable program code for measuring further comprises:
computer usable program code for pasting the selection of data into the second application, while maintaining the first application in the foreground of the computer.

17. A computer for managing data that is gathered, comprising:
a display for displaying a user interface metaphor for a first application;
a processor configured for:
executing a second application in a foreground of the computer and the first application in a background of the computer;
receiving a command to direct a selection of data from the second application to the first application, while maintaining the second application in the foreground of the computer; and
directing the selection of data to the first application, while maintaining the second application in the foreground of the computer.

18. The computer of claim 17, wherein the user interface metaphor is a graphic that is symbolic of data reception.

19. The computer of claim 17, wherein the command is a drag and drop action.

20. The computer of claim 17, wherein the command is a keyboard stroke combination.
